(19) United States
(12) Patent Application Publication
(10) Pub. No.: US 2010/0096237 A1
(43) Pub. Date: Apr. 22, 2010

(54) Damper clutch of torque converter

(75) Inventors: Sung Yeol Kim, Suwon-city (KR); Jin Hyun Kim, Seoul (KR); Sung Yop Lee, Yongin-city (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/552,113

(22) Filed: Sep. 1, 2009

(30) Foreign Application Priority Data
Oct. 21, 2008 (KR) 10-2008-0103302

(51) Int. Cl. F16D 13/76

(52) U.S. Cl. 192/70.17

(57) ABSTRACT

A damper clutch of a torque converter of the present invention can reduce generation of abnormal vibration and a booming noise in low speed and also, can lower engaging torque and enhance fuel efficiency with multiple elastic damping force. A damper clutch of a torque converter includes a plurality of damper spring that are disposed along radial direction and a plurality of spring supporter that are disposed between the damper springs and pressurizes the damper springs along radial direction when power is delivered from a piston to a turbine, wherein each two spring supporters, putting opposite, form a group and each group has different length for supplying multiple elastic damping force.

### CROSS-REFERENCE TO RELATED APPLICATION

The present application claims priority to Korean Patent Application No. 10-2008-0103302 filed on Oct. 21, 2008, the entire contents of which are incorporated herein for all purposes by this reference.

### BACKGROUND OF THE INVENTION

1. Field of the Invention

The present invention relates to a damper clutch of a torque converter for an automatic transmission.

More particularly, the present invention relates to a damper clutch of a torque converter that can reduce generation of abnormal vibration and a booming noise in low speed and also, can lower engaging torque and enhance fuel efficiency with multiple elastic damping force.

2. Description of the Related Art

A general torque converter includes an impeller that rotates by receiving driving torque of an engine, a turbine that rotates receiving oil ejected from the impeller and a stator that converts flowing direction of the oil and creates reaction torque.

A damper clutch (or a lock-up clutch) is used for directly connecting the engine and an automatic transmission when load of the engine is increased and power delivery efficiency is deteriorated.

The damper clutch is disposed between a front cover directly connected the engine and the turbine, and delivers power directly to the turbine.

The damper clutch includes double damper springs with different spring stiffness. The first spring stiffness decides a booming noise in low speed and the second stiffness decides a maximum torque, and it is preferable that the first spring stiffness is lowered and the second stiffness is heightened.

However, as shown in FIG. 5, in the general damper clutch equipped with double damper springs, lowering first spring stiffness (K1) is limited and an abnormal vibration due to reflection of vibration where spring stiffness is rapidly changed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a damper clutch of a torque converter of the present invention can reduce generation of abnormal vibration and a booming noise in low speed and also, can lower engaging torque and enhance fuel efficiency with multiple elastic damping force.

In an aspect of the present invention, the damper clutch of a torque converter may include a plurality of damper springs that are disposed along a circumferential direction of the damper clutch, and a plurality of spring supporters that are disposed between the damper springs and pressurize the damper springs along the circumferential direction when power is delivered from a piston to a turbine, wherein each two spring supporters, putting symmetric, form a group and each group has different lengths for supplying multiple elastic damping force.

The damper springs may include double springs having an outer spring and an inner spring placed in the outer spring, the outer spring being connected to adjacent spring supporters and one end of the inner spring being connected to one of the adjacent spring supporters.

The spring supporters may be sequentially disposed along the circumferential direction and lengths of the spring supporters may be sequentially and gradually increased along the circumferential direction, wherein relative length differences of adjacent spring supporters sequentially correspond to an angle of approximately 0.5° to approximately 0.7°.

The spring supporters may form four groups, which have relative different lengths, wherein the each two spring supporters forming the group has the same length.

In another aspect of the present invention, the damper clutch of a torque converter may include a plurality of damper springs that are disposed along a circumferential direction of the damper clutch, and a plurality of spring supporters that are disposed between the damper springs and pressurize the damper springs along the circumferential direction when power is delivered from a piston to a turbine, wherein each two spring supporters, putting symmetric and having the same length, form a group and each group has different lengths that are sequentially and gradually increased along the circumferential direction for supplying multiple elastic damping force.

In further another aspect of the present invention, the damper clutch of a torque converter may include a drive plate including a plurality of spring supporters formed along an outer circumference portion of the drive plate, wherein one side of the spring supporter is opened, a plurality of damper springs disposed between the spring supporters along a circumferential direction of the damper clutch, a plurality of supporting plates disposed between the spring supporters and receiving the damper springs therebetween, and a plurality of connecting members, one end portion of which are connected to a driven plate and the other end portion of which are slidably inserted into the opened side of the spring supporter and contact the supporting plates, wherein the spring supporters supports the supporting plates to pressurize the damper springs along the circumferential direction when power is delivered from a piston connected to the drive plate to a turbine connected to the driven plate, and wherein each two spring supporters, putting symmetric, form a group and each group has different lengths for supplying multiple elastic damping force.

The spring supporters may be sequentially disposed along the circumferential direction and lengths of the spring supporters are sequentially and gradually increased along the circumferential direction.

The damper springs may include double springs having an outer spring and an inner spring placed in the outer spring, the outer spring being connected to adjacent spring supporters and one end of the inner spring being connected to one of the adjacent spring supporters.

The each two spring supporters forming the group may have the same length.

In further another aspect of the present invention, the damper clutch of a torque converter may include a plurality of damper springs that are disposed along a circumferential direction of the damper clutch and a plurality of spring supporters that are disposed between the damper springs and pressurize the damper springs along the circumferential direction when power is delivered from a piston to a turbine, wherein the damper springs include double springs having an outer spring and an inner spring placed in the outer spring, the outer spring being connected to adjacent spring supporters and wherein the inner springs have different lengths for supplying multiple elastic damping force.

The inner springs, putting symmetric may form a group and one end of the inner spring may be and one end of the inner spring may be connected to one of the adjacent spring supporters.

The inner springs may be sequentially disposed along the circumferential direction and lengths of the inner springs are sequentially and gradually increased along the circumferential direction.

The each two inner springs forming the group have the same length.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a partial cross-sectional view of a torque converter according to an exemplary embodiment of the present invention.

FIG. 2 is a front view of a damper clutch according to an exemplary embodiment of the present invention.

FIG. 3 is a graph showing operating effect of the damper clutch according to an exemplary embodiment of the present invention.

FIG. 4 is a cross-sectional view of a damper clutch according to another exemplary embodiment of the present invention.

FIG. 5 is a graph showing operating effect of a conventional damper clutch.

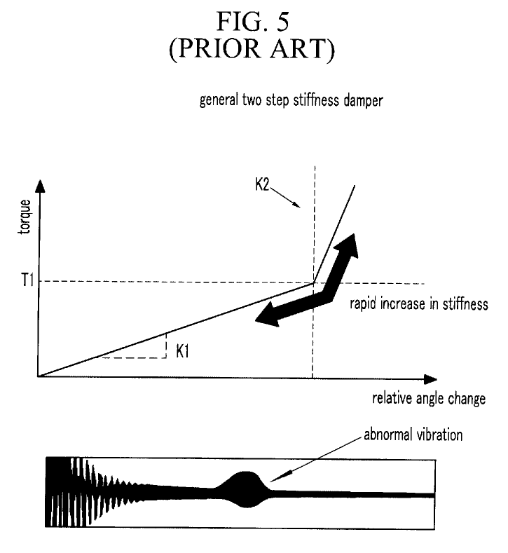

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

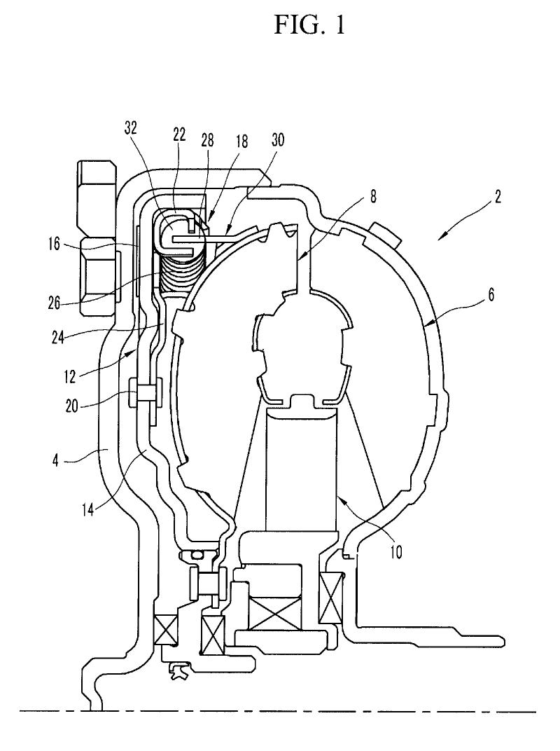

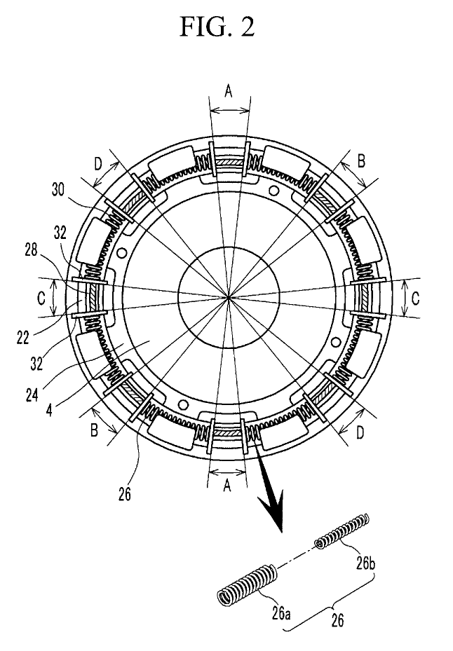

FIG. 1 is a partial cross-sectional view of a torque converter according to an exemplary embodiment of the present invention and FIG. 2 is a front view of a damper clutch according to an exemplary embodiment of the present invention.

A torque converter 2 includes a front cover 4 that is connected to a crankshaft of an engine and rotates, an impeller 6 that is connected to the front cover 4 and rotates with the front cover 4, a turbine 8 oppositely disposed to the impeller 6 and a stator 10 that converts flowing direction of the oil and creates reaction torque.

The stator 10 has the same rotation center of the front cover 4 and a damper clutch 12 for directly connecting the engine and a transmission is disposed between the front cover 4 and the turbine 8.

The damper clutch 12 includes a circle shaped plate of piston 14 and a friction member 16, which may contact to the front cover 4, is provided to the piston 14.

The piston 14 is rotatably and simultaneously movably along axial direction disposed.

A torsional damper 18 is disposed to the damper clutch 12 for absorbing twist and vibration when the friction member 16 and the front cover 4 are closely contacted.

The torsional damper 18 includes a drive plate 24, a plurality of damper spring 26 and a driven plate 30.

The drive plate 24 is connected to the piston 14 by a rivet 20 and spring supporters 22 are protrudedly disposed along circumferential direction of the drive plate 24.

The plurality of damper springs 26 are disposed between the spring supporters 22.

An end of the driven plate 30 is fixed to the turbine 8 and a connecting member 28 protruded in an axial direction of the turbine 8 is slidably inserted into the spring supporter 22.

The spring supporter 22 is formed as a rectangle tube along an outer circumference portion of the drive plate 24 and includes one side opened. The connecting member 28 is slidably inserted into the spring supporter 22 through the opened side and contacts a supporting plate 32 supporting the damper spring 26 in the circumferential direction of the drive plate 24.

With above said scheme, when power is delivered from the piston 14 to the turbine 8, twist impact and vibration can be absorbed by expansion and contraction of the damper spring 26.

The damper spring 26 of the torque converter 2 according to an exemplary embodiment of the present invention can be double damper springs with different spring stiffness.

The plurality of spring supporter 22 disposed between the damper springs 26 pressurizes the damper springs 26 along circumferential direction when power is delivered from the piston 14 to the turbine 8, and each two spring supporters 22, putting opposite and having the same length (or the same relative central angle), form a group and each group has different lengths (or different relative central angles) for supplying multiple elastic damping force.

As shown in FIG. 2, when eight damper springs 26 are provided in the exemplary embodiment, and also spring supporters 22 are provided between the damper springs 26 and four group are formed with each two spring supporters 22, putting opposite and having the same length (or the same relative central angle).

If four groups are sequentially designated as group A, B, C and D, the lengths (or relative central angle) of the spring supporters 22 are sequentially and gradually increased from the group A to the group D.

The central angles of the spring supporters 22 is not limited to disclosed embodiments, but, on the contrary, can be intended to cover various modifications and equivalent arrangements according to required stiffness and an engine performance.

Also, the increase of the central angles (or relative lengths) of the spring supporter 22 can be random.

While the spring supporters 22 forming the group have the same length (or the same relative central angle) in the drawing, however, the spring supporters 22 forming the group may have different same length (or different relative central angle).

In the exemplary embodiment of the present invention, the increase of the central angle of the spring supporter 22 is 0.5° to 0.7°, it can be various according to requirement.

As shown in FIG. 2, the damper spring 26 according to the exemplary embodiment of the present invention can be formed by a double spring.

If the damper spring 26 is formed by a double spring, an outer spring 26a is formed by first spring stiffness and an inner spring 26b inserted into the outer spring 26a is formed by second spring stiffness.

Both ends of the outer spring 26a can be supported by the spring supporter 22 and one end of the inner spring 26b is supported by the spring supporter 22.

If the damper springs 26 are formed by double damper springs with different spring stiffness, contacts of the spring supporters 22 and the inner springs 26b can be sequentially realized from the group D, of which central angle is the largest, to the group A, of which central angle is the smallest. Thus, five steps of resilience with one step of the outer spring 26a with the first stiffness and four steps of the inner spring 26b with the second stiffness can be realized.

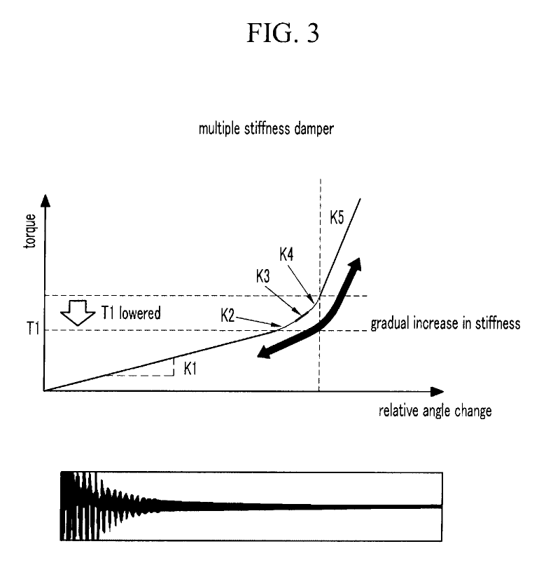

That is, as shown in FIG. 3, when power is delivered from the piston 14 to the turbine 8, resilience by the outer spring 26a absorbs impact before the spring supporter 22 contacts the inner spring 26b (K1). Resilience by the inner spring 26b absorbs impact after the group D contacts the spring supporter 22 (K2). Resilience by the inner spring 26b absorbs impact after the group C contacts the spring supporter 22 (K3). Resilience by the inner spring 26b absorbs impact after the group B contacts the spring supporter 22 (K4). And resilience by the inner spring 26b absorbs impact after the group A contacts the spring supporter 22 (K5).

As shown in FIG. 3, stiffness can sequentially be increased, thus generation of abnormal vibration can be prevented, timing of delivering a maximum torque T1 can be lowered, a booming noise in low speed can be reduced and fuel consumption can be improved.

If the damper spring 26 is formed with one spring with constant elastic force, four steps of resilience can be realized.

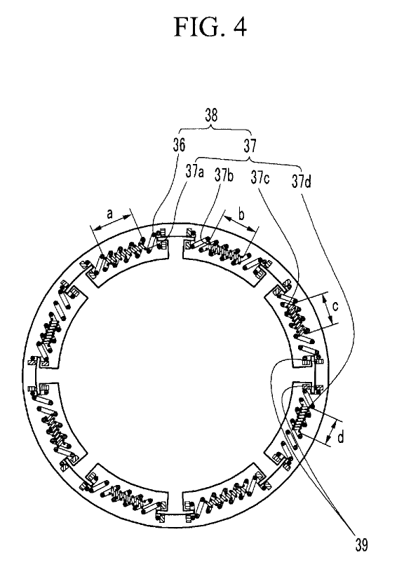

FIG. 4 is a cross-sectional view of a damper clutch according to another exemplary embodiment of the present invention.

The damper clutch of a torque converter according to another exemplary embodiment of the present invention include a plurality of damper springs 38 that are disposed along a circumferential direction of the damper clutch and a plurality of spring supporters 39 that are disposed between the damper springs 38 and pressurize the damper springs 38 along the circumferential direction when power is delivered from the piston 14 to the turbine 8, wherein the damper springs 38, as a double spring 38 have an outer spring 36 and an inner spring 37 placed in the outer spring 36.

The outer spring 36 is connected to adjacent spring supporters 38 and one end of the inner spring 37 is connected to one of the adjacent spring supporters 38, and wherein each two inner springs 37a, 37b, 37c and 37d putting symmetric, form a group and each group has different lengths for supplying multiple elastic damping force.

The inner springs 37a, 37b, 37c and 37d is sequentially disposed along the circumferential direction and lengths of the inner springs 37a, 37b, 37c and 37d are sequentially and gradually decreased along the circumferential direction in the drawing.

The each two inner springs 37a, 37b, 37c and 37d forming the group have the same length, however, various alternatives and modifications can be realized.

In the another embodiment of the present invention, as shown in FIG. 3, when power is delivered from the piston 14 to the turbine 8, resilience by the outer spring 36 absorbs impact before the spring supporter 39 contacts the first inner spring 37a (K1). Resilience by the first inner spring 37a absorbs impact the spring supporter 39 contacts the first inner spring 37a (K2). Resilience by the second inner spring 37b absorbs impact after the spring supporter 39 contacts the second inner spring 37b (K3). Resilience by the inner spring 27c absorbs impact the spring supporter 39 contacts the inner spring 27c (K4). And resilience by the fourth inner spring 37d absorbs impact after the spring supporter 39 contacts the fourth inner spring 37d (K5).

In another embodiment of the present invention, the spring supporters 39 are disposed at the same distance from the other spring supporters 39.

And also, in another embodiment of the present invention, as shown in FIG. 3, stiffness can sequentially be increased, thus generation of abnormal vibration can be prevented, timing of delivering a maximum torque Ti can be lowered, a booming noise in low speed can be reduced and fuel consumption can be improved.

For convenience in explanation and accurate definition in the appended claims, the terms “outer” and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A damper clutch of a torque converter comprising:
a plurality of damper springs that are disposed along a circumferential direction of the damper clutch; and
a plurality of spring supporters that are disposed between the damper springs and pressurize the damper springs along the circumferential direction when power is delivered from a piston to a turbine,
wherein each two spring supporters, putting symmetric, form a group and each group has different lengths for supplying multiple elastic damping force.

2. The damper clutch of a torque converter of claim 1, wherein the damper springs include double springs having an outer spring and an inner spring placed in the outer spring, the outer spring being connected to adjacent spring supporters and one end of the inner spring being connected to one of the adjacent spring supporters.

3. The damper clutch of a torque converter of claim 1, wherein the spring supporters are sequentially disposed along the circumferential direction and lengths of the spring supporters are sequentially and gradually increased along the circumferential direction.

4. The damper clutch of a torque converter of claim 3, wherein relative length differences of adjacent spring supporters sequentially correspond to an angle of approximately 0.5° to approximately 0.7°.

5. The damper clutch of a torque converter of claim 1, wherein the spring supporters form four groups, which have relative different lengths.

6. The damper clutch of a torque converter of claim 5, wherein the each two spring supporters forming the group has the same length.

7. A damper clutch of a torque converter comprising:
a plurality of damper springs that are disposed along a circumferential direction of the damper clutch; and
a plurality of spring supporters that are disposed between the damper springs and pressurize the damper springs along the circumferential direction when power is delivered from a piston to a turbine,
wherein each two spring supporters, putting symmetric and having the same length, form a group and each group has different lengths that are sequentially and gradually increased along the circumferential direction for supplying multiple elastic damping force.

8. A damper clutch of a torque converter comprising:
a drive plate including a plurality of spring supporters formed along an outer circumference portion of the drive plate, wherein one side of the spring supporter is opened;
a plurality of damper springs disposed between the spring supporters along a circumferential direction of the damper clutch;
a plurality of supporting plates disposed between the spring supporters and receiving the damper springs therebetween; and
a plurality of connecting members, one end portion of which are connected to a driven plate and the other end portion of which are slidably inserted into the opened side of the spring supporter and contact the supporting plates;
wherein the spring supporters supports the supporting plates to pressurize the damper springs along the circumferential direction when power is delivered from a piston connected to the drive plate to a turbine connected to the driven plate, and
wherein each two spring supporters, putting symmetric, form a group and each group has different lengths for supplying multiple elastic damping force.

9. The damper clutch of a torque converter of claim 8, wherein the spring supporters are sequentially disposed along the circumferential direction and lengths of the spring supporters are sequentially and gradually increased along the circumferential direction.

10. The damper clutch of a torque converter of claim 8, wherein the damper springs include double springs having an outer spring and an inner spring placed in the outer spring, the outer spring being connected to adjacent spring supporters and one end of the inner spring being connected to one of the adjacent spring supporters.

11. The damper clutch of a torque converter of claim 8, wherein the each two spring supporters forming the group has the same length.

12. A damper clutch of a torque converter comprising:
a plurality of damper springs that are disposed along a circumferential direction of the damper clutch; and
a plurality of spring supporters that are disposed between the damper springs and pressurize the damper springs along the circumferential direction when power is delivered from a piston to a turbine,
wherein the damper springs include double springs having an outer spring and an inner spring placed in the outer spring, the outer spring being connected to adjacent spring supporters
wherein the inner springs have different lengths for supplying multiple elastic damping force.

13. The damper clutch of a torque converter of claim 12, wherein the inner springs, putting symmetric, form a group and one end of the inner spring is connected to one of the adjacent spring supporters.

14. The damper clutch of a torque converter of claim 13, wherein the inner springs are sequentially disposed along the circumferential direction and lengths of the inner springs are sequentially and gradually increased along the circumferential direction.

15. The damper clutch of a torque converter of claim 14, wherein the each two inner springs forming the group has the same length.
